(19) United States
(12) Patent Application Publication
(10) Pub. No.: US 2026/0119426 A1
(43) Pub. Date: Apr. 30, 2026

(54) INTELLIGENCE PROCESSING UNIT AND METHOD OF FINDING EXTREME VALUE

(71) Applicant: SigmaStar Technology Ltd., Xiamen (CN)

(72) Inventor: Huice JIANG, Shanghai (CN)

(21) Appl. No.: 19/358,582

(22) Filed: Oct. 15, 2025

(30) Foreign Application Priority Data
Oct. 30, 2024 (CN) 202411525361.8

(51) Int. Cl. G06F 13/28

(52) U.S. Cl. CPC G06F 13/28; G06F 2213/28

(57) ABSTRACT

An intelligent processing unit includes a first memory, a second memory, and a vector core circuit. The first memory stores batch data. The second memory stores mask data. The vector core circuit is configured to: find a first extreme value among a plurality of data values in the batch data, and store the first extreme value and a first location index value of the first extreme value to the first memory; adjust a corresponding bit in the mask data according to the first location index value; and find a second extreme value among the plurality of data values according to the corresponding bit, and store the second extreme value and a second location index value of the second extreme value to the first memory, wherein the second extreme value is different from the first extreme value.

This application claims the benefit of China application Serial No. CN202411525361.8, filed on Oct. 30, 2024, the subject matter of which is incorporated herein by reference.

### BACKGROUND OF THE INVENTION

### Field of the Invention

The present application relates to an intelligent processing unit, and more particularly to an intelligent processing unit and a method able to process in parallel multiple sets of batch data to find multiple extreme values in the multiple sets of batch data.

### Description of the Related Art

A TopK operator, which is a type operation frequently utilized for machine learning and deep learning, has a main function of selecting first K number of largest (or smallest) values from one data set or tensor data, and is thus often applied to utilization scenarios that need to sort or filter data or select critical features. In the prior art, the execution of a TopK operation for data processing is usually handled by a central processing unit (CPU) in a system. If there are a large number of sets of data to be processed, a CPU nonetheless can only execute one after another the TopK operations of the data to be processed due to its sequential data processing ability, hence resulting in rather unsatisfactory overall processing efficiency.

### SUMMARY OF THE INVENTION

In some embodiments, it is an object of the present application to provide an intelligent processing unit and a method able to process in parallel multiple sets of batch data to find multiple extreme values in the multiple sets of batch data, so as to improve drawbacks of the prior art.

In some embodiments, an intelligent processing unit includes a first memory, a second memory, and a vector core circuit. The first memory stores batch data. The second memory stores mask data. The vector core circuit is configured to: find a first extreme value among a plurality of data values in the batch data, and store the first extreme value and a first location index value of the first extreme value to the first memory; adjust a corresponding bit in the mask data according to the first location index value; and find a second extreme value among the plurality of data values according to the corresponding bit, and store the second extreme value and a second location index value of the second extreme value to the first memory, wherein the second extreme value is different from the first extreme value.

In some embodiments, a method performed by an intelligent processing unit to find an extreme value includes operations of: finding a first extreme value among a plurality of data values, and storing the first extreme value and a first location index value of the first extreme value to a first memory of the intelligent processing unit; adjusting a corresponding bit in mask data according to the first location index value; and finding a second extreme value among the plurality of data values according to the corresponding bit, and storing the second extreme value and a second location index value of the second extreme value to the first memory, wherein the second extreme value is different from the first extreme value.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 shows a schematic diagram of an intelligent processing unit according to some embodiments of the present application.

FIG. 2 shows a flowchart of execution of a TopK operator by the intelligent processing unit in FIG. 1 according to some embodiments of the present application.

FIG. 3A shows a schematic diagram of multiple sets of batch data in FIG. 1 according to some embodiments of the present application.

FIG. 3B shows a schematic diagram of the multiple sets of mask data in FIG. 1 according to some embodiments of the present application.

FIG. 3C shows a schematic diagram of an operation for finding a first maximum value in the multiple sets of batch data in FIG. 3A according to some embodiments of the present application.

FIG. 3D shows a schematic diagram of an operation for finding a corresponding bit in the multiple sets of mask data in FIG. 3B according to some embodiments of the present application.

FIG. 3E shows a schematic diagram of an operation for finding a second maximum value in the multiple sets of batch data in FIG. 3C according to some embodiments of the present application.

FIG. 4 is a flowchart of operations for finding the second maximum value by the intelligent processing unit in FIG. 1 according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

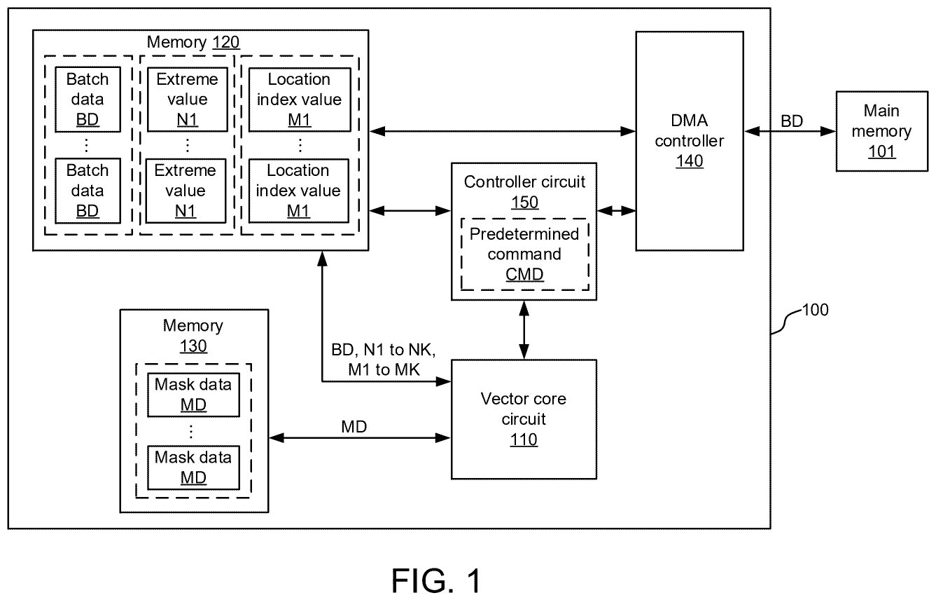

FIG. 1 shows a schematic diagram of an intelligent processing unit 100 according to some embodiments of the present application. In some embodiments, the intelligent processing unit 100 may be applied to machine learning or deep learning, and is able to execute a TopK operator in the field of machine learning (or deep learning). In some embodiments, a TopK operator may be used to find first K number of maximum values in a data set (for example but not limited to, tensor data) and location index values of the first K number of maximum values in the data set, wherein the function may be used to sort data, filter data or select critical features. It should be understood that, in some embodiments, a TopK operator may also be modified to find first K number of minimum values and location index values of the K number of minimum values. Thus, in different embodiments, the intelligent processing unit 100 may find an extreme value (which may be a maximum value or a minimum value) in a data set by means of executing a TopK operator. For better illustration purposes, in the embodiments to be described below, to find a maximum value is taken as an example; however, it should be noted that the present invention is not limited to the example.

The intelligent processing unit 100 includes a vector core circuit 110, a memory 120, a memory 130, a direct memory access (DMA) controller 140 and a controller circuit 150. The controller circuit 150 may be configured with and/or control the vector core circuit 110, the memory 120 and the DMA controller 140. The DMA controller 140 may read multiple sets of batch data BD from a main memory 101, and sequentially store the batch data BD to the memory 120. In some embodiments, the DMA controller 140 may be coupled to the main memory 101 via an external memory interface (EMI). In some embodiments, the main memory 101 may obtain the multiples sets of batch data BD from a central processing unit (CPU, not shown) in a system, wherein the CPU may divide tensor data according to an innermost dimension of the tensor data or multiple consecutive dimensions of the innermost dimension to generate the batch data BD.

The controller circuit 150 has a predetermined command CMD stored therein, and is able to execute the predetermined command CMD to control the circuits such as the vector core circuit 110, the memory 120 and the DMA controller 140 to start executing an operation corresponding to the TopK operator, so as to find K number of extreme values in the batch data BD and locations of the K extreme values in the batch data BD. For example, the controller circuit 150 may execute the predetermined command CMD to initialize the vector core circuit 110, so as to configure related calculation parameters, operating modes and types of operations executed in the vector core circuit 110 and configure the vector core circuit 110 to being in a state of able to perform extreme value searching. Similarly, the controller circuit 150 may execute the predetermined command CMD to initialize the memory 120 and the memory 130, so that data between the memory 120 and the memory 130 has one-on-one mapping correspondence to assist in the execution of extreme value searching. In some embodiments, the predetermined command CMD may be, for example but not limited to, a jump command. Because the individual data sizes of the multiple sets of batch data BD are the same as one another, the controller circuit 150 may repeatedly execute the jump command to sequentially read the batch data BD from the main memory 101 via the DMA controller 140 according to a fixed address shift, thereby executing the operation corresponding to the TopK operator on the batch data BD. Thus, the size of command needed for executing the TopK operator can be significantly reduced.

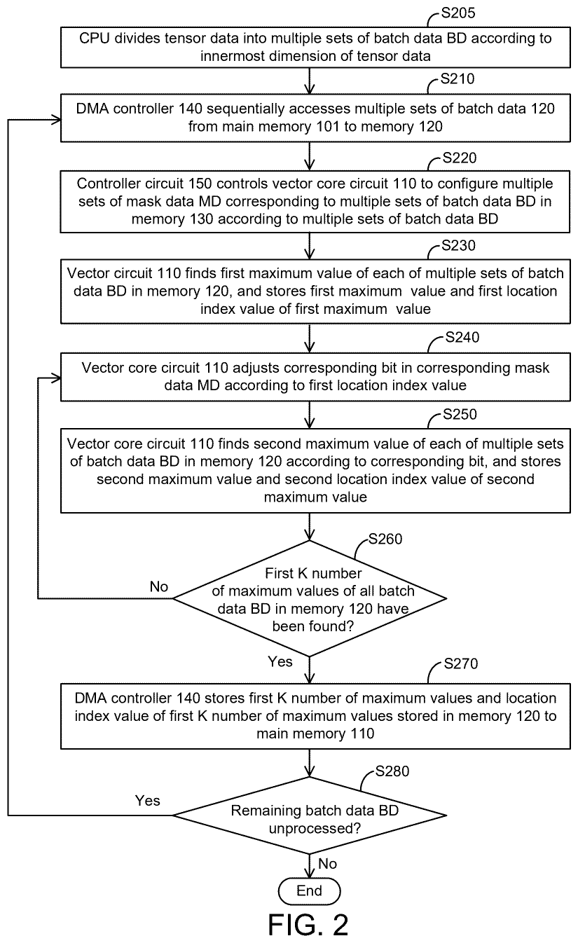

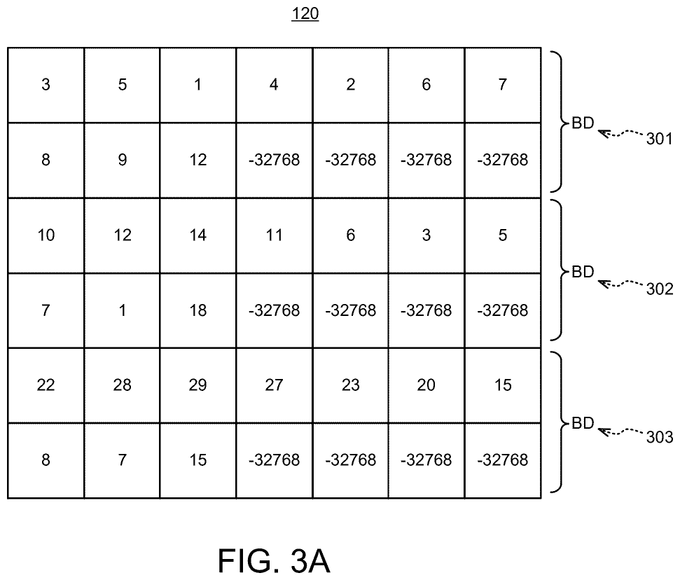

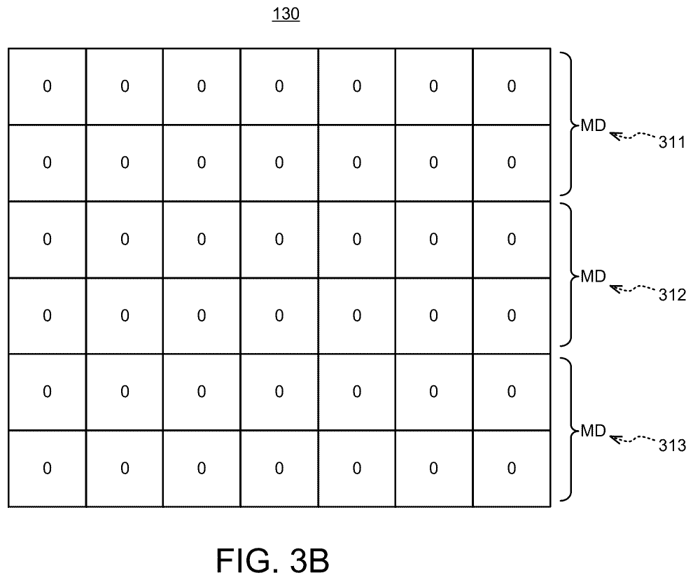

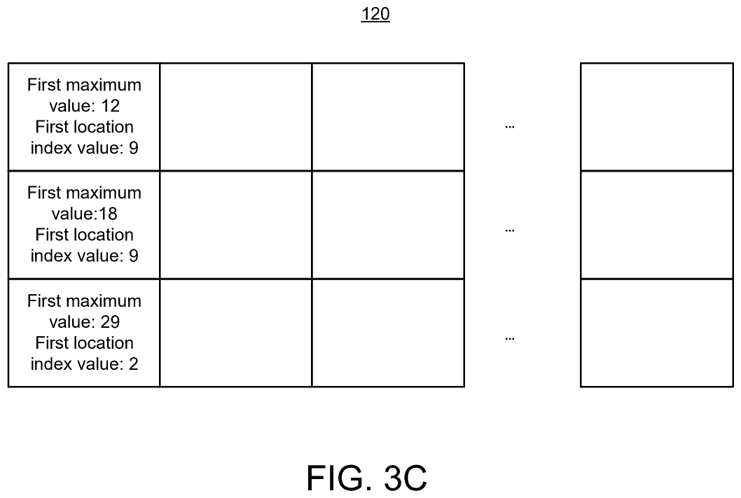

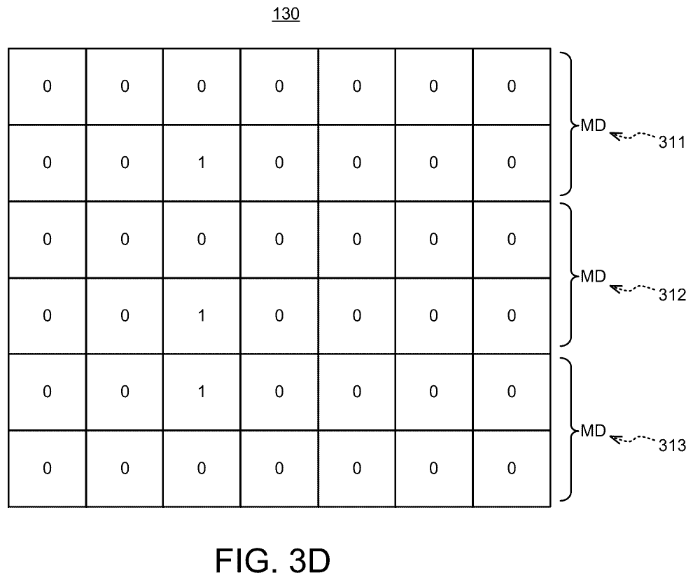

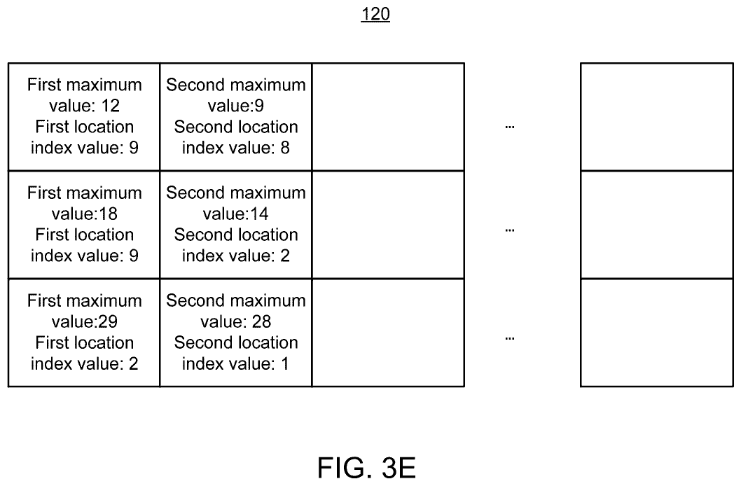

The vector core circuit 110 may include, for example but not limited to, calculation circuits such as a comparator, a register, a multiplier, an adder, a multiply-add-accumulate circuit, to perform related calculations needed for machine learning and/or deep learning. In some embodiments, the vector core circuit 110 may use circuits such as a comparator and a register to execute related operations corresponding to the TopK operator. Associated details herein are to be described with reference to FIG. 2 and FIG. 3A to FIG. 3E below.

The memory 120 stores the multiple sets of batch data BD, and stores operation results of the operations corresponding to the TopK operator executed by the vector core circuit 110, that is, first K number of extreme values N1 to NK and location index values M1 to MK of the first K number of extreme values, where K may be a positive integer greater than or equal to 2. In some embodiments, the memory 120 may be, for example but not limited to, an L2 memory. The memory 130 stores multiple sets of mask data MD corresponding to the multiple sets of batch data BD, wherein each set of mask data MD corresponds to one specific set of batch data BD, with such correspondence to be described below with reference to FIG. 3A and FIG. 3B below. In some embodiments, the memory 130 may be, for example but not limited to, a static random access memory (SRAM).

In some embodiments, once the first K number of extreme values N1 to NK of each of all of the multiple sets of batch data BD stored in the memory 120 are found, the controller circuit 150 may control the DMA controller 140 to store the first K number of extreme values N1 to NK and the location index values M1 to MK of the first K number of extreme values stored in the memory 120 to the main memory 101, so as to release the storage space of the memory 120 to continue processing operations of subsequent TopK operators.

FIG. 2 shows a flowchart of execution of a TopK operator by the intelligent processing unit 100 in FIG. 1 according to some embodiments of the present application. In FIG. 2, operations executable by the intelligent processing unit 100 include operation S205 to operation S280. For better understanding, to find a maximum value is taken as an example in the process in FIG. 2; however, it should be noted that the present invention is not limited to the example. It should be understood that the process in FIG. 2 may also be modified to finding a minimum value.

In operation S205, a CPU divides tensor data into multiple sets of batch data BD according to an innermost dimension of the tensor data. As described above, the CPU may divide the tensor data into the multiple sets of batch data BD according to an innermost dimension of the tensor data. For example, if dimensions of the tensor data are (5, 4, 3, 2), the CPU may divide the tensor data into the multiple sets of batch data BD according to the innermost dimension 2. Alternatively, the CPU may divide the tensor data into the multiple sets of batch data BD according to a product of multiple consecutive dimensions including the innermost dimension (for example, a product 6 of the innermost dimension 2 and the neighboring dimension 3).

In operation S210, the DMA controller 140 sequentially accesses the multiple sets of batch data BD from the main memory 101 to the memory 120. In operation S220, the controller circuit 150 controls the vector core circuit 110 to configure multiple sets of mask data MD corresponding to the multiple sets of batch data BD in the memory 130 according to the multiple sets of batch data BD.

FIG. 3A shows a schematic diagram of the multiple sets of batch data BD in FIG. 1 according to some embodiments of the present application. Refer to FIG. 3A for the description on operation S210. FIG. 3A shows three sets of batch data BD stored in the memory 120. Each of the sets of batch data BD includes multiple data values. In some embodiments, the DMA controller 140 may selectively fill the batch data BD with at least one predetermined value so that the number of data values of one set of batch data BD may correspond to one memory row of the memory 120. For example, if each data value may be an integer represented hexadecimally with a symbol, the predetermined value may be set to −32768 (that is, a predetermined minimum value represented hexadecimally) to find the maximum value. Conversely, the predetermined value may be set to a predetermined maximum value represented hexadecimally to find the minimum value. To meet the manner of data access for hardware, the DMA controller 140 may store one set of batch data BD to one memory row of the memory 120, and fill the location having an empty data value in the batch data BD with the predetermined value −32768. As shown in FIG. 3A, if the number of data values that one memory row of the memory 120 can store is 14, the DMA controller 140 may fill back locations of empty data values in the first set of batch data BD (denoted as batch data 301) with several of the predetermined value −32768, so that the number of data values of one single set of batch data BD is 14. Similarly, the DMA controller 140 may fill the locations having empty data values in the second set of batch data BD (denoted as batch data 302) and the third set of batch data BD (denoted as batch data 303) with several of the predetermined value −32768. Thus, each set of batch data BD exactly fills one memory row of the memory 120, and the predetermined value −32768 additionally filled in does not affect the operation of the TopK operator for finding the maximum value.

FIG. 3B shows a schematic diagram of the multiple sets of mask data MD in FIG. 1 according to some embodiments of the present application. Refer to FIG. 3B for the description on operation S220. FIG. 3B shows three sets of mask data MD stored in the memory 130. In some embodiments, each set of mask data MD includes multiple bits, and an arrangement of data of the multiple bits respectively corresponds to an arrangement of multiple data values in each set of batch data BD. For example, the first set of mask data MD (denoted as mask data 311) corresponds to the batch data 301 in FIG. 3A, the second set of mask data MD (denoted as mask data 312) corresponds to the batch data 302 in FIG. 3A, and the third set of mask data MD (denoted as mask data 313) corresponds to the batch data 303 in FIG. 3A. Multiple bits in each of the mask data 311, the mask data 312 and the mask data 313 are pre-configured as a first predetermined value (for example, a logic value of 0). Since correspondence exists between the locations of the multiple bits and the multiple values in the corresponding mask data MD, the vector core circuit 110 may determine according to the correspondence above whether to omit the corresponding data values in the corresponding batch data BD during the execution of the TopK operator.

Again referring to FIG. 2, in operation S230, the vector core circuit 110 finds a first maximum value in each of the multiple sets of batch data BD in the memory 120, and stores the first maximum value and a first location index value of the first maximum value. In operation S240, the vector core circuit 110 adjusts the corresponding bit in the corresponding mask data MD according to the first location index value.

FIG. 3C shows a schematic diagram of an operation for finding a first maximum value in the multiple sets of batch data BD in FIG. 3A according to some embodiments of the present application. Refer to both FIG. 3A and FIG. 3C for the description on operation S230. In some embodiments, the vector core circuit 110 may use an internal comparator and an internal register to perform operation S230. Taking the batch data 301 for example, the comparator may compare the data value 3 (having a location index value 0) in the batch data 301 with the data value 5 (having a location index value 1), and store the data value 5 which is larger to the register. Next, the comparator may compare the next data value 1 (having a location index value 2) in the batch data 301 with the data value 5 currently stored in the register. Since the data value 5 currently stored in the register is larger, the comparator may continue to compare the next data value 4 in the batch data 301 with the data value 5 currently stored in the register, and so forth. Once all data values in the batch data 301 have undergone the comparison, the vector core circuit 110 may find that the first maximum value in the batch data 301 is the data value 12 and the first location index value is 9. The first location index value above is for indicating the location of the data value 12 (for example, the location of the 9^{th} bit) among the multiple data values of the batch data 301. With the same operation, the vector core circuit 110 may find that the first maximum value in the batch data 302 is the data value 18 and the corresponding first location index value is 9. The vector core circuit 110 may find that the first maximum value in the batch data 303 is the data value 29 and the corresponding first location index value is 2.

FIG. 3D shows a schematic diagram of an operation for finding a corresponding bit in multiple sets of mask data MD in FIG. 3B according to some embodiments of the present application. Refer to both FIG. 3B and FIG. 3D for the description on operation S240. In the previous operations, the vector core circuit 110 has found that the first location index value of the first maximum value in the batch data 301 is 9. According to this first location index value, the vector core circuit 110 may adjust, in the mask data 311 corresponding to the batch data 301 in the memory 130, the corresponding bit corresponding to this first location index value from a first predetermined value (for example, logical 0) to a second predetermined value (for example, logical 1). Similarly, according to the first location index value of the batch data 302, the vector core circuit 110 may adjust, in the mask data 312 corresponding to the batch data 302 in the memory 130, the corresponding bit corresponding to the first location index value from the first predetermined value to the second predetermined value. According to the first location index value of the batch data 303, the vector core circuit 110 may adjust, in the mask data 313 corresponding to the batch data 303 in the memory 130, the corresponding bit corresponding to the first location index value from the first predetermined value to the second predetermined value.

Again referring to FIG. 2, in operation S250, the vector core circuit 110 finds a second maximum value in each of the multiple sets of batch data BD in the memory 120 according to the corresponding bit, and stores the second maximum value and a second location index value of the second maximum value.

FIG. 3E shows a schematic diagram of an operation for finding a second maximum value in the multiple sets of batch data BD in FIG. 3A according to some embodiments of the present application. Refer to FIG. 3C, FIG. 3D and FIG. 3E for the description on operation S250. In some embodiments, the vector core circuit 110 may eliminate the first maximum value from the multiple sets of batch data BD according to a bit with the second predetermined value in the multiple sets of mask data MD in the memory 130, and find the second maximum value from the multiple remaining data values in the multiple sets of batch data after the elimination. Taking the batch data 301 for example, the vector core circuit 110 may learn according to the corresponding mask data 311 in the memory 130 that the data value 12 is the first maximum value found previously (that is, the location of the first maximum value is learned according to the corresponding bit having the second predetermined value in the mask data 311). In this case, the vector core circuit 110 may eliminate the data value 12 from the batch data 301, and find from the remaining data value 3, data value 5, data value 1, data value 4, data value 2,data value 6, data value 7, data value 8, data value 9 and multiple predetermined values −32768, that the second maximum value is 9 and the second location index value thereof is 8 (that is, the data value 9 is the 8^{th} bit in the batch data 301). Based on the similar operation, the vector core circuit 110 may find from the batch data 302 that the second maximum value is the data value 14 and the second location index value is 2, and may find from the batch data 303 that the second maximum value is the data value 28 and the second location index value is 1.

Again referring to FIG. 2, in operation S260, it is determined whether the first K number of maximum values of all of the batch data BD in the memory 120 have been found. If not, operation S240 is performed again to adjust a corresponding bit in the corresponding mask data MD according to the second location index value, so as to accordingly find a third maximum value of each of the multiple sets of batch data BD and a third location index value, until the first K number of maximum values of all of the batch data BD in the memory 120 have been found. If so, operation S270 is performed. It should be understood that, the extreme value N1 in FIG. 1 may be the first maximum value above, the extreme value N2 may be the second maximum value above, and so forth. Thus, the extreme value NK may be the K-th maximum value. Similarly, the location index value M1 is the first location index value above, the location index value M2 is the second location index value above, and the location index value MK is the Kth location index value above.

In operation S270, the DMA controller 140 stores the first K number of maximum values and the location index values of the first K number of maximum values stored in the memory 120 to the main memory 101. In operation S280, the controller circuit 150 determines via the DMA controller 140 whether there are remaining batch data BD that is unprocessed. If so, operation S210 is performed again to continue processing the remaining batch data BD. If not, related operations of the TopK operator end.

In some related art, the TopK operator is executed by a CPU in a system. In such related art, the CPU can only sequentially execute one after another multiple sets of data to be processed to sequentially find the first K number of maximum values of each of these sets of data, hence resulting in rather unsatisfactory overall processing efficiency. Compare the related art above, in some embodiments of the present application, the multiple sets of batch data BD can be processed in parallel to execute the TopK operator by increasing the number of hardware of the vector core circuit 110 in the intelligent processing unit 100, so as to more efficiently find the first K number of maximum values of each of the multiple sets of batch data BD. Thus, the intelligent processing unit 100 is able to improve decision efficiency and processing performance of machine learning, deep learning and/or neural networks to thereby achieve clear improvement in the application fields above.

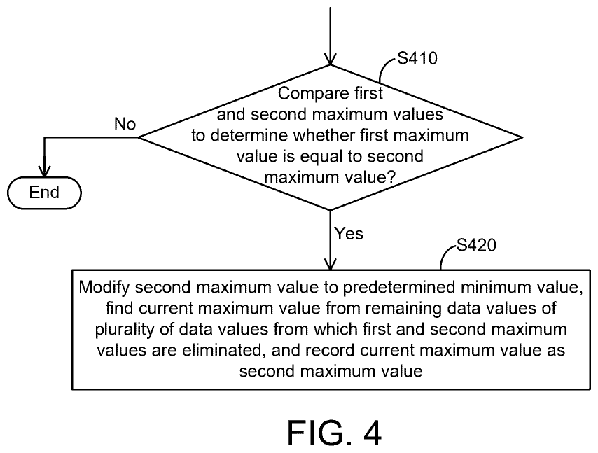

FIG. 4 shows a flowchart of operations for finding the second maximum value by the intelligent processing unit 100 in FIG. 1 according to some embodiments of the present application. In some embodiments, the multiple operations in FIG. 4 may be additional operations executable in operation S250 in FIG. 2. In operation S410, a first maximum value and a second maximum value are compared to determine whether the first maximum value is equal to the second maximum value. If so, operation S420 is performed. In operation S420, the second maximum value is modified to a predetermined minimum value, a current maximum value in the remaining data values of a plurality of data values from which the first maximum value and the second maximum value are eliminated is found, and the current maximum value is recorded as the second maximum value. If not, the operation ends.

For example, once the first maximum value (that is, the data value 12) in the batch data 301 is found, the vector core circuit 110 may store the first maximum value (that is, the data value 12) to the register thereof. Next, in the previous example, the vector core circuit 110 finds that the second maximum value in the batch data 301 is the data value 9. The vector core circuit 110 may compare this second maximum value with the first maximum value stored in the register. In this example, the data value 9 is different from the data value 12, and thus the vector core circuit 110 does not perform other operations. In other examples, if the vector core circuit 110 finds that the second maximum value of the batch data 301 is also the data value 12, the vector core circuit 110 learns that the first maximum value is equal to the second maximum value. In this case, the vector core circuit 110 modifies the second maximum value to a predetermined minimum value, finds the current maximum value from the remaining data values of the batch data 301 from which the first maximum value and the second maximum value are eliminated, records the current maximum value as the new second maximum value, and stores the second maximum value and the second location index value thereof. With the operations above, it is ensured that all of the first K number of maximum values found by the intelligent processing unit 100 have different values.

As described above, in the processes of the embodiments above, to find a maximum value is taken as an example; however, it should be noted that the present invention is not limited to the example. In other embodiments, the processes of the embodiments above may also be modified to finding a minimum value.

In some embodiments, a method for finding an extreme value may be performed by, for example but not limited to, the intelligent processing unit 100 in FIG. 1.

In an operation, a first extreme value among a plurality of data values is found, and the first extreme value and a first location index value of the first extreme value are stored to a first memory of an intelligent processing unit. In another operation, a corresponding bit in mask data is adjusted according to the first location index value. In still another operation, a second extreme value among the plurality of data values is found according to the corresponding bit, and the second extreme value and a second location index value of the second extreme value are stored to the first memory, wherein the second extreme value is different from the first extreme value.

Details associated with the multiple operations of the method for finding an extreme value above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations, or the operations may be performed in different orders, or performed simultaneously or partially simultaneously.

In conclusion, the intelligent processing unit and the method for finding an extreme value provided according to some embodiments of the present application are able to process in parallel multiple sets of batch data to thereby improve processing efficiency of execution of a TopK operator.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An intelligent processing unit, comprising:
a first memory, storing batch data;
a second memory, storing mask data; and
a vector core circuit, configured to:
find a first extreme value among a plurality of data values in the batch data, and store the first extreme value and a first location index value of the first extreme value to a first memory;
adjust a corresponding bit in the mask data according to the first location index value; and
find a second extreme value among the plurality of data values according to the corresponding bit, and store the second extreme value and a second location index value of the second extreme value to the first memory, wherein the second extreme value is different from the first extreme value.

2. The intelligent processing unit according to claim 1, wherein, after finding the first extreme value, the vector core circuit adjusts the corresponding bit from a first predetermined value to a second predetermined value according to the first location index value.

3. The intelligent processing unit according to claim 1, wherein the vector core circuit eliminates the first extreme value from the plurality of data values according to the corresponding bit, and finds the second extreme value from remaining data values of the plurality of data values after the elimination.

4. The intelligent processing unit according to claim 1, wherein the vector core circuit further compares the first extreme value and the second extreme value, and if the second extreme value is equal to the first extreme value, the vector core circuit further modifies the second extreme value to a predetermined value, finds a current extreme value from remaining data values of the plurality of data values from which the first extreme value and the second extreme value are eliminated, and records the current extreme value as the second extreme value.

5. The intelligent processing unit according to claim 1, further comprising:
a direct memory access (DMA) controller, reading the batch data from a main memory and storing the batch data to the first memory.

6. The intelligent processing unit according to claim 5, wherein the DMA controller further selectively fills the plurality of data values with a predetermined value such that the number of the plurality of data values corresponds to a memory row of the first memory.

7. The intelligent processing unit according to claim 1, further comprising:
a controller circuit, storing a predetermined command, and executing the predetermined command to configure the vector core circuit, the first memory and the second memory to find the first extreme value and the second extreme value.

8. The intelligent processing unit according to claim 1, wherein the mask data comprises a plurality of bits, an arrangement of the plurality of bits respectively corresponds to an arrangement of the plurality of data values, and the plurality of bits comprise the corresponding bit.

9. The intelligent processing unit according to claim 1, wherein the first location index value indicates a location of the first extreme value in the plurality of data values.

10. A method for finding an extreme value, performed by an intelligent processing unit, the method comprising:
finding a first extreme value among a plurality of data values in batch data is found, and storing the first extreme value and a first location index value of the first extreme value to a first memory of the intelligent processing unit;
adjusting a corresponding bit in mask data according to the first location index value; and
finding a second extreme value among the plurality of data values according to the corresponding bit, and storing the second extreme value and a second location index value of the second extreme value to the first memory,
wherein the second extreme value is different from the first extreme value.
